(19) United States
(12) Patent Application Publication
(10) Pub. No.: US 2025/0313079 A1
(43) Pub. Date: Oct. 9, 2025

(54) WHEEL MOTOR STRUCTURE

(71) Applicant: HL MANDO CORPORATION, Gyeonggi-do (KR)

(72) Inventor: SungSoo LEE, Gyeonggi-do (KR)

(21) Appl. No.: 18/271,022

(22) PCT Filed: Mar. 31, 2023
(86) PCT No.: PCT/KR2023/004354

§ 371 Date: Oct. 26, 2024

(30) Foreign Application Priority Data
Apr. 26, 2022 (KR) 10-2022-0051162

(51) Int. Cl. B60K 7/00; B60B 7/00; B60K 17/12

(52) U.S. Cl. CPC B60K 7/0007; B60B 7/0086; B60K 17/12; B60B 2900/511; B60B 2900/513

(57) ABSTRACT

The present invention discloses a wheel motor structure in which dustproof and protective effects can be further increased and heat radiation efficiency can be further increased and which includes a stator, a rotor, a cover coupled to one surface of the rotor to cover one surface of the stator, a coupling shaft which passes through the stator and the cover, and an oil seal disposed in a space between the cover and the coupling shaft to seal the space, wherein heat radiating fins extending in a radial direction are formed to protrude from both surfaces of the cover. Accordingly, the dustproof and waterproof effects of the wheel motor structure can be further increased and the heat radiation efficiency can be further increased

### TECHNICAL FIELD

The present invention relates to a wheel motor structure, and more specifically, to a wheel motor structure in which dustproof and waterproof effects are further increased and heat radiation efficiency is also further increased.

### BACKGROUND ART

Wheel motors are devices which are mounted on wheels of driving apparatuses such as vehicles and directly perform functions such as acceleration, deceleration, braking, and steering of the driving apparatuses.

A wheel motor includes a stator and a rotor capable of rotating with respect to the stator. The stator includes a coil which is a wound wire, and the rotor includes a magnet. When a current is supplied to the stator, a magnetic field is generated around the stator, and thus the rotor receives an electromagnetic force and rotates.

In this case, since a problem such as a malfunction may occur when moisture or foreign matter enters the stator and the rotor, a dustproof and waterproof structure to address the problem is required. In addition, a heat radiation structure for radiating heat generated by a wire is also required.

The conventional wheel motor structure has a waterproof structure disposed to surround peripheries of a stator and a rotor. However, it is difficult for such a type of the wheel motor structure to radiate heat generated by a wire.

Accordingly, the development of a wheel motor structure in which dustproof and waterproof effects are further increased and heat radiation efficiency is also excellent may be considered.

Korean Patent Publication No. 10-2021-0104629 discloses a waterproof structure of an in-wheel motor. Specifically, a waterproof structure of an in-wheel motor including a tire fastening unit on a cover coupled to a side surface of a rim is disclosed.

However, such a type of the in-wheel motor does not disclose a structure for radiating heat generated in a space inside the cover.

Korean Patent Registration No. 10-2183332 discloses a cooling device for a vehicle wheel motor. Specifically, a cooling device for a vehicle wheel motor in which a circulator gear is mounted on a motor shaft is disclosed.

However, since separate components for cooling are required for such a type of the cooling device, an increase in volume and an increase in manufacturing process are inevitable. In addition, there is a possibility that foreign matter or moisture may enter the wheel motor through an air outlet.
(Patent Document 1) Korean Patent Publication No. 10-2021-0104629 (Aug. 25, 2021)
(Patent Document 2) Korean Patent Registration No. 10-2183332 (Nov. 26, 2020)

### DISCLOSURE

### Technical Problem

The present invention is directed to providing a wheel motor structure in which dustproof and waterproof effects are further increased and heat radiation efficiency is also further increased.

The present invention is also directed to providing a wheel motor structure having increased durability.

The present invention is also directed to providing a wheel motor structure which is advantageous for miniaturization.

### Technical Solution

According to an aspect of the present invention, there is provided a wheel motor structure according to an embodiment of the present invention, which includes a stator which is formed in a disc shape and in which a plurality of slots are disposed along a circumference of the stator, wherein wires are wound in the plurality of slots, a rotor which is disposed to surround an outer side of the stator in a radial direction, of which a central axis is positioned collinearly with a central axis of the stator, and which is rotatably coupled with respect to the stator, a left cover coupled to one surface of the rotor to cover one surface of the stator, a right cover coupled to the other surface of the rotor to cover the other surface of the stator, a coupling shaft which passes through and is coupled to each of a central portion of the stator, a central portion of the left cover, and a central portion of the right cover, and an oil seal disposed in a space between the coupling shaft and any one of the left cover and the right cover to seal the space, wherein the rotor includes a motor ring formed in a ring shape and a wheel ring which is formed in a ring shape and of which an outer circumferential surface is tightly coupled to an inner circumferential surface of the motor ring, and heat radiating fins extending in the radial direction are formed to protrude from both side surfaces of each of the left cover and the right cover.

In the rotor, the inner circumferential surface of the motor ring and the outer circumferential surface of the wheel ring may be coupled in a welding manner.

A permanent magnet may be disposed on an inner circumferential surface of the wheel ring.

A plurality of permanent magnets may be disposed along the inner circumferential surface of the wheel ring.

The wheel motor structure may further include a dust cap coupled to any one of the left cover and the right cover with the oil seal interposed therebetween and disposed to surround the oil seal.

A through hole may be formed in a portion of the dust cap to allow a space between the dust cap and the oil seal to communicate with an outer space of the dust cap.

The wheel motor structure may further include a gasket which is positioned between the rotor and any one of the left cover and the right cover, is tightly coupled to each of the rotor and any one of the left cover and the right cover, and seals a space between the rotor and any one of the left cover and the right cover.

A sealant may be applied on a periphery of the gasket.

The wheel motor structure may further include a harness which includes a plurality of wires wired from the stator, passes through the coupling shaft, and extends in a direction away from the stator.

A sealant may be applied on a portion of the harness close to the coupling shaft.

### Advantageous Effects

According to the above configuration, among various effects of the present invention, effects which can be obtained through the above-described solutions are as follows.

First, a wheel motor structure according to the present invention includes a stator, a rotor, a cover coupled to one surface of the rotor to cover one surface of the stator, a coupling shaft which passes through and is coupled to the stator and the cover, and an oil seal disposed in a space between the cover and the coupling shaft to seal the space. In this case, heat radiating fins extending in a radial direction are formed to protrude from both surfaces of the cover.

Accordingly, dustproof and waterproof functions in the space between the cover and the stator can be performed by the oil seal. In addition, an air contact area of the cover is increased due to the heat radiating fins, and heat radiation efficiency can be further increased. As a result, the dustproof and waterproof effects can be further increased, and the heat radiation efficiency can also be further increased.

In addition, the rotor includes a ring-shaped motor ring and a wheel ring coupled to an inner circumferential surface of the motor ring. In this case, an outer circumferential surface of the wheel ring is tightly coupled to the inner circumferential surface of the motor ring.

Accordingly, the coupling between the motor ring and the wheel ring can be more firmly achieved. Accordingly, the durability of the entire wheel motor structure including the rotor can be further increased.

In addition, a dustproof and waterproof structure including the oil seal is positioned inside the rotor in the radial direction. In addition, separate components for heat radiation are not required.

Accordingly, dustproof and waterproof functions can be performed without increasing a diameter of the entire wheel motor structure. In addition, since separate components for heat radiation are not required, the wheel motor structure is advantageous for miniaturization.

### DESCRIPTION OF DRAWINGS

FIG. 1 is a perspective view illustrating a wheel motor structure according to an embodiment of the present invention;

FIG. 2 is a front cross-sectional view illustrating the wheel motor structure of FIG. 1;

FIG. 3 is an exploded view illustrating the wheel motor structure of FIG. 1;

FIG. 4 is a front view illustrating a rotor included in the wheel motor structure of FIG. 1;

FIG. 5 is an exploded view illustrating the rotor of FIG. 4; and

FIGS. 6 and 7 are exploded views illustrating a stator included in the wheel motor structure in FIG. 1.

### MODE OF THE INVENTION

Hereafter, a wheel motor structure 1 according to embodiments of the present invention will be described in more detail with reference the accompanying drawings.

In the following description, the description for some components may be omitted in order to clarify the characteristics of the present invention.

In the present specification, even when different embodiments are described, the same components will be denoted by the same reference numerals, and redundant descriptions will be omitted.

The accompanying drawings are only provided so that the embodiments disclosed in the specification are easily understood, and the technical spirit of the present invention is not limited thereto,

The singular forms include the plural forms, unless the context clearly indicates otherwise.

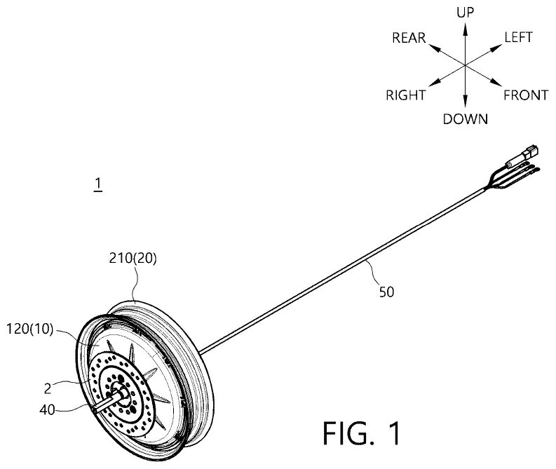

Terms “upward,” “downward,” “leftward,” “rightward,” “forward,” and “rearward,” used in the following description will be understood with reference to a coordinate system illustrated in FIG. 1.

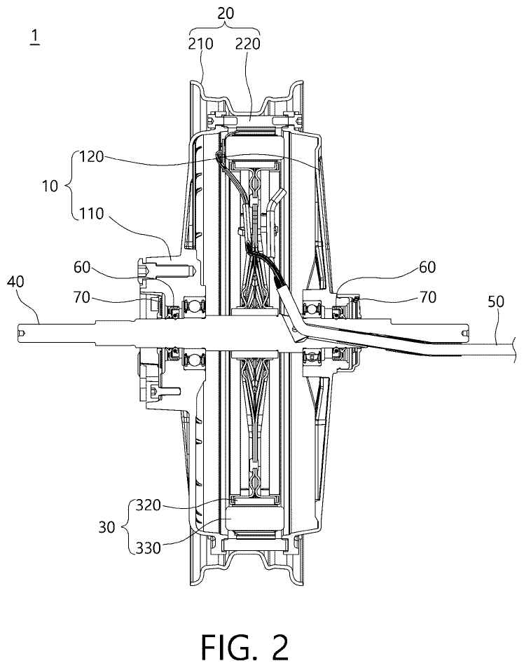

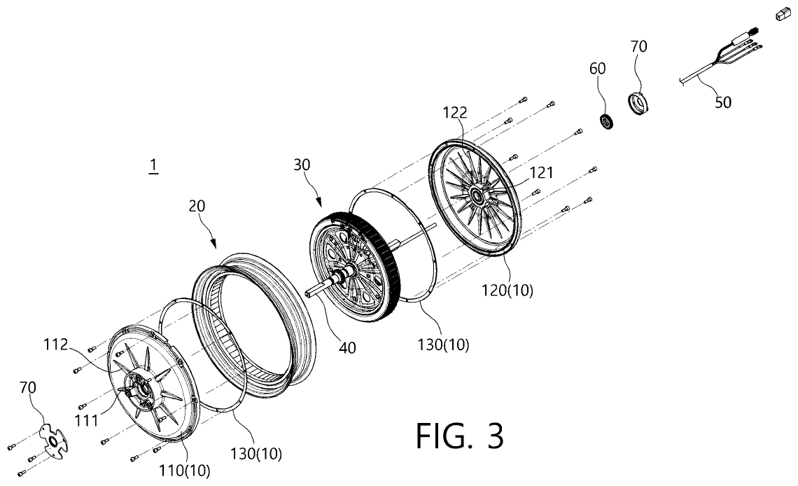

Hereinafter, the wheel motor structure 1 will be described with reference to FIGS. 1 to 3.

The wheel motor structure 1 is a device which is mounted on a wheel of a driving apparatus and directly performs functions such as acceleration, deceleration, braking, and steering of the driving apparatus. In one embodiment, the wheel motor structure 1 may be mounted on a wheel of a vehicle.

In the illustrated embodiment, the wheel motor structure 1 includes a frame unit 10, a rotor 20, a stator 30, a coupling shaft 40, a harness 50, oil seals 60, and dust caps 70.

The frame unit 10 constitutes exteriors of both sides of the wheel motor structure 1 and protects the rotor 20 and the stator 30, which will be described below, from foreign matter. In the illustrated embodiment, the frame unit 10 constitutes the left and right exteriors of the wheel motor structure 1.

The frame unit 10 is positioned at both sides of the wheel motor structure 1. In the illustrated embodiment, the frame unit 10 is positioned at a left side and a right side of the wheel motor structure 1. Accordingly, a left side and a right side of the stator 30 may be covered by the frame unit 10.

In the illustrated embodiment, the frame unit 10 includes a left cover 110, a right cover 120, and a gasket 130.

The left cover 110 constitutes the left exterior of the wheel motor structure 1.

The left cover 110 is positioned at the left side of the wheel motor structure 1. Accordingly, the left side of the stator 30 may be covered by the left cover 110.

The left cover 110 is coupled to a left surface of the rotor 20, which will be described below. In one embodiment, the left cover 110 may be coupled to the left surface of the rotor 20 in a bolt coupling manner. In the above embodiment, bolt members are disposed along outer circumferences of the left cover 110 and the rotor 20.

The left cover 110 is formed in a shape corresponding to the left surface of the rotor 20. In the illustrated embodiment, the left cover 110 is formed in a disc shape.

A left through hole 111 is formed in a central portion of the left cover 110. The coupling shaft 40 is inserted into the left through hole 111.

In addition, left heat radiating fins 112 are formed on both surfaces of the left cover 110.

The left heat radiating fins 112 assist for radiation of heat generated by the stator 30 to the outside.

The left heat radiating fins 112 extend on the both surfaces of the left cover 110 in a radial direction and are formed to protrude from the both surfaces of the left cover 110.

Accordingly, a space in the wheel motor structure 1 is sealed by the frame unit 10, an air contact area of the left cover 110 is also increased by the left heat radiating fins 112, and thus, heat radiation efficiency can be further increased. That is, dustproof and waterproof effects can be further increased, and heat radiation efficiency can also be further increased.

In addition, since separate components for heat radiation are not required, the wheel motor structure 1 is advantageous for miniaturization.

In one embodiment, a plurality of left heat radiating fins 112 may be provided.

The left cover 110 is coupled to the right cover 120 with the rotor 20 and the stator 30 interposed therebetween.

The right cover 120 constitutes the right exterior of the wheel motor structure 1.

The right cover 120 is positioned at the right side of the wheel motor structure 1. Accordingly, the right side of the stator 30 may be covered by the right cover 120.

The right cover 120 is coupled to a right surface of the rotor 20, which will be described below. In one embodiment, the right cover 120 may be coupled to the right surface of the rotor 20 in a bolt coupling manner. In the above embodiment, bolt members are disposed along the outer circumferences of the right cover 120 and the rotor 20.

The right cover 120 is formed in a shape corresponding to the right surface of the rotor 20. In the illustrated embodiment, the right cover 120 is formed in a disc shape.

In one embodiment, the right cover 120 may be formed in a shape symmetrical to the left cover 110 with respect to the stator 30.

In one embodiment, the right cover 120 may be formed in the shape corresponding to the left cover 110. In the illustrated embodiment, the right cover 120 is formed in a different shape from the left cover 110.

A right through hole 121 is formed in a central portion of the right cover 120. The coupling shaft 40 is inserted into the right through hole 121.

In addition, right heat radiating fins 122 are formed on both surfaces of the right cover 120.

The right heat radiating fins 122 assist for radiation of heat generated by the stator 30 to the outside.

The right heat radiating fins 122 extend on the both surfaces of the right cover 120 in the radial direction and are formed to protrude from both surfaces of the right cover 120. An effect of the right cover 120 is the same as an effect of the left heat radiating fin 112.

In the illustrated embodiment, the right heat radiating fins 122 are formed in a different shape from the left heat radiating fins 112. However, a structure of the right heat radiating fins 122 is not limited to an illustrated structure and may be formed in any structure capable of radiating heat transferred to the right cover 120 to the outside.

In one embodiment, a plurality of right heat radiating fins 122 may be provided. In this case, the number of right heat radiating fins 122 may not necessarily be the same as the number of left heat radiating fins 112.

A disc brake 2 is installed on any one of the left cover 110 and the right cover 120. In the illustrated embodiment, the disc brake 2 is coupled to the right cover 120.

The gasket 130 is disposed between the rotor 20 and any one of the left cover 110 and the right cover 120.

The gasket 130 functions as a packing material which seals a space between the frame unit 10 and the rotor 20.

The gasket 130 is positioned between the rotor 20 and any one of the left cover 110 and the right cover 120 and tightly coupled to the rotor 20 and any one of the left cover 110 and the right cover 120. In one embodiment, the gasket 130 is coupled to the rotor 20 and any one of the left cover 110 and the right cover 120 in a bolt coupling manner.

The gasket 130 is formed in a ring shape. In addition, an outer diameter of the gasket 130 is smaller than or equal to an outer diameter of the rotor 20.

In one embodiment, a sealant may be applied on a periphery of the gasket 130. Since an outer diameter of the gasket 130 is not greater than an outer diameter of the rotor 20, and the periphery of the gasket 130 is sealed by the sealant, foreign matter can be prevented from entering the wheel motor structure 1 even when the gasket 130 is coupled to the rotor 20 in the bolt coupling manner.

The gasket 130 may be provided as a plurality of gaskets 130. In the illustrated embodiment, the gaskets 130 are each provided between the left cover 110 and the rotor 20 and between the right cover 120 and the rotor 20, and thus a total of two gaskets 130 are provided.

The rotor 20 and the stator 30 are disposed between the left cover 110 and the right cover 120.

When a current is supplied to the stator 30, the rotor 20 receives an electromagnetic force due to a magnetic field around the stator 30 and rotates.

The rotor 20 is formed in a ring shape. A hollow into which the stator 30 is inserted is formed inside the rotor 20. In addition, the left cover 110 and the right cover 120 are coupled to the left surface and the right surface of the rotor 20, respectively.

The wheel of the driving apparatus may be coupled to an outer circumferential surface of the rotor 20. In one embodiment, hooking steps may be formed on both sides of the rotor 20 to prevent an arbitrary separation of the wheel.

The stator 30 is disposed inside the rotor 20.

The stator 30 receives a current to generate a magnetic field around the stator 30.

The stator 30 is positioned inside the rotor 20 and does not move relatively with respect to the driving apparatus.

The stator 30 is disposed so that the rotor 20 surrounds an outer side of the stator 30 in the radial direction. To this end, the outer diameter of the stator 30 is smaller than the inner diameter of the rotor 20.

In addition, the stator 30 is coupled to an inner circumferential surface of the rotor 20. In this case, the rotor 20 is rotatably coupled with respect to the stator 30.

The stator 30 is formed in a disc shape. In one embodiment, a central axis of the stator 30 is positioned collinearly with a central axis of the rotor 20.

The coupling shaft 40 passes through and is coupled to the central portion of the left cover 110, the central portions of the right cover 120, and a central portion of the stator 30. Accordingly, the left cover 110, the right cover 120, and the stator 30 may be coupled side by side along an extension direction of the coupling shaft 40.

A space through which the harness 50 passes is formed inside the coupling shaft 40.

The harness 50 includes a plurality of wires wired from the stator 30. The harness 50 may be electrically connected to a power source such as a battery.

The harness 50 extends in a direction away from the stator 30. In the illustrated embodiment, the harness 50 passes through a portion of the coupling shaft 40 and extends leftward.

In one embodiment, a sealant may be applied on a periphery of the harness 50. Accordingly, a coupling portion between the harness 50 and other components may be sealed to prevent foreign matter from entering the wheel motor structure 1.

The harness 50 passing through the stator 30 and the frame unit 10 extends through the oil seals 60 and a dust cap 70.

The oil seals 60 prevent foreign matter and moisture from entering an inner space of the frame unit 10.

Each of the oil seals 60 is disposed in a space between the coupling shaft 40 and any one of the left cover 110 and the right cover 120. In this case, the oil seals 60 are coupled to the coupling shaft 40 and any one of the left cover 110 and the right cover 120 to seal the space.

Accordingly, the oil seals 60 may block the inner space of the frame unit 10 from communicating with an outer space. Accordingly, dustproof and waterproof functions for the space between the cover and the stator 30 can be performed.

Since the oil seals 60 are positioned close to the coupling shaft 40, the oil seals 60 are positioned inside the frame unit 10, the rotor 20, and the stator 30 in the radial direction. Accordingly, dustproof and waterproof functions can be performed without increasing the diameter of the entire wheel motor structure 1.

The oil seal 60 is formed in a ring shape. In one embodiment, the coupling shaft 40 and the harness 50 may pass through and be coupled to a hollow of the oil seal 60.

The oil seal 60 may be formed of a high elastic material. For example, the oil seal 60 may be formed of a synthetic rubber resin.

The plurality of oil seals 60 may be provided. In the illustrated embodiment, the oil seals 60 are provided at a left side and a right side of the frame unit 10, and thus a total of two oil seals 60 are provided.

The dust cap 70 is coupled to one surface of the oil seal 60.

The dust cap 70 performs a function of preventing damage to the oil seal 60 due to a physical impact.

The dust cap 70 is coupled to any one of the left cover 110 and the right cover 120 with the oil seal 60 interposed therebetween. That is, the dust cap 70 is positioned at one side, which is opposite to the frame unit 10, of the oil seal 60.

In addition, the dust cap 70 is disposed to surround the oil seal 60. Accordingly, the oil seal 60 can be protected from fragments flying toward the oil seal 60.

In one embodiment, a through hole of the harness 50 may be formed in a central portion of the dust cap 70.

In another embodiment, a through hole or groove may be formed in a part of a dust cap 70 to allow a space between the dust cap 70 and each oil seal 60 to communicate with an outer space. Accordingly, moisture which has entered between the oil seal 60 and the dust cap 70 may be drained through the through hole.

The dust cap 70 may be provided as a plurality of dust caps 70. In this case, the number of dust caps 70 may be the same as the number of oil seals 60.

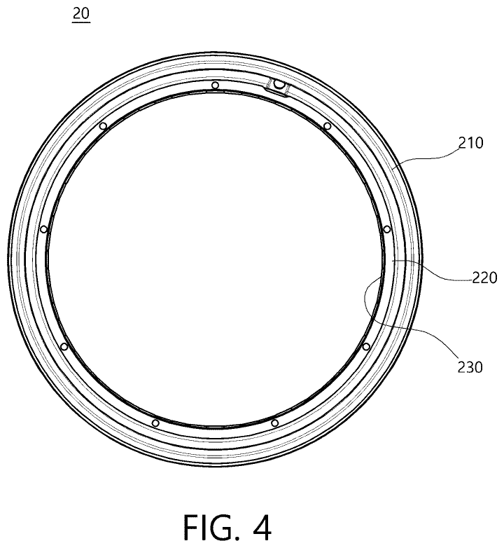

As described above, each component of the wheel motor structure 1 has been described. Hereafter, the rotor 20 and the stator 30 are described in more detail with reference to FIGS. 4 to 7.

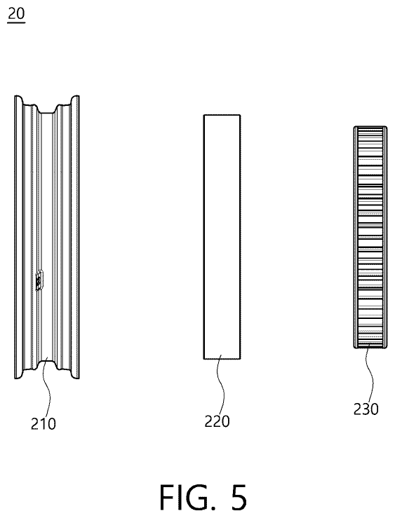

First, the rotor 20 will be described in more detail with reference to FIGS. 4 and 5.

In the illustrated embodiment, the rotor 20 includes a motor ring 210, a wheel ring 220, and a permanent magnet 230.

The motor ring 210 is positioned on the outer circumference of the rotor 20 to constitute an exterior of the rotor 20.

The motor ring 210 is a component directly coupled to the wheel of the driving apparatus.

The motor ring 210 is formed in a ring shape. The wheel of the driving apparatus is disposed on and coupled to an outer circumferential surface of the motor ring 210 so that the wheel of the driving apparatus is surrounded. In one embodiment, hooking steps may be formed on both sides of the motor ring 210 to prevent an arbitrary separation of the wheel.

The wheel ring 220 is coupled to an inner side of the motor ring 210.

The wheel ring 220 is disposed on an inner circumference of the rotor 20 to constitutes the inner circumferential surface of the rotor 20.

The wheel ring 220 is formed in a ring shape corresponding to an inner circumference of the motor ring 210. An outer circumferential surface of the wheel ring 220 is tightly coupled to an inner circumferential surface of the motor ring 210.

In one embodiment, the outer circumferential surface of the wheel ring 220 is coupled to the inner circumferential surface of the motor ring 210 in a welding manner. Accordingly, the motor ring 210 and the wheel ring 220 can be more firmly coupled. Accordingly, the durability of the entire wheel motor structure 1 including the rotor 20 can be further increased.

The permanent magnet 230 is disposed on an inner circumferential surface of the wheel ring 220.

When a current is supplied to the stator 30, the permanent magnet 230 receives an electromagnetic force due to a magnetic field around the stator 30.

The permanent magnet 230 is disposed between the inner circumferential surface of the wheel ring 220 and an outer circumferential surface of the stator 30. In this case, the permanent magnet 230 is attached to the inner circumferential surface of the wheel ring 220 and disposed to be spaced apart from the outer circumferential surface of the stator 30. This is to prevent the rotor 20 including the permanent magnet 230 from colliding with the stator 30 while the rotor 20 rotates with respect to the stator 30.

The permanent magnet 230 may be provided as a plurality of permanent magnets 230. In the illustrated embodiment, the plurality of magnets are disposed along the inner circumferential surface of the wheel ring 220.

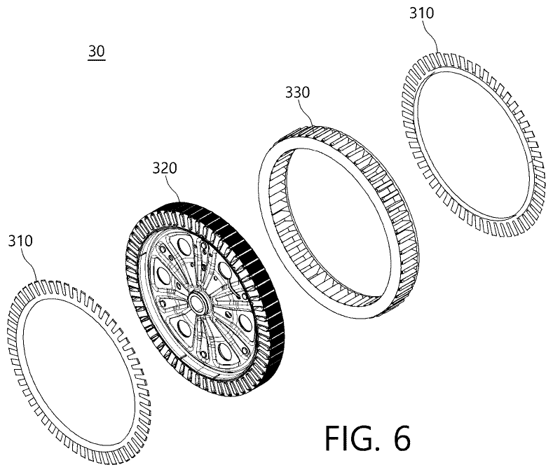

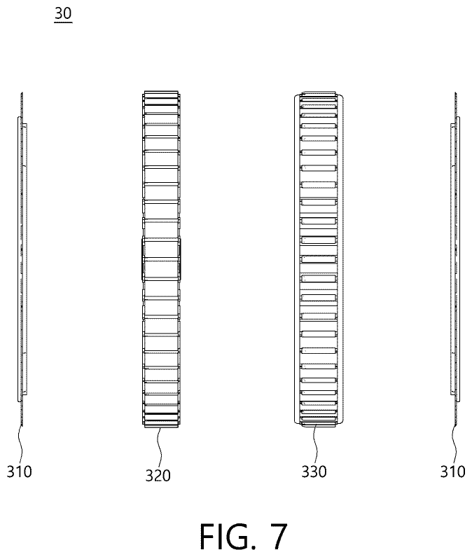

Then, the stator 30 will be described in more detail with reference to FIGS. 6 and 7.

In the illustrated embodiment, the stator 30 includes cores 310, slots 320, and an insulator 330.

The cores 310 constitute a magnetic path of a magnetic field generated by the stator 30. The cores 310 are coupled to the plurality of slots 320 in which wires are wound around the outer circumferential surface of the stator 30. In this case, the plurality of slots 320 are disposed along an outer circumference of the stator 30.

The insulator 330 is disposed between two slots 320 adjacent to each other. The insulator 330 electrically insulates the two slots 320 adjacent to each other. To this end, the insulator 330 is formed of an electrically insulating material.

The wires wound in the slot 320 are collected and electrically connected to the harness 50. When a current is supplied to the harness 50, the current flows in the wires wound in the slot 320. Accordingly, a magnetic field is generated around the stator 30.

Since the permanent magnet 230 is positioned outside the stator 30 in the radial direction, the permanent magnet 230 receives an electromagnetic force generated due to a magnetic field around the stator 30. The rotor 20 including the permanent magnet 230 is rotated with respect to the stator 30 by the electromagnetic force. As a result, the wheel coupled to the rotor 20 may rotate and the driving apparatus may travel.

Although exemplary embodiments of the present invention have been described above, the present invention is not limited to the configurations of the embodiments described above.

In addition, the present invention may be variously modified and changed by those skilled in the art within the range without departing from the sprit and the scope of the present invention appended in the following claims.

In addition, all or a part of each embodiment described above may be selectively combined to achieve various modifications.

### DESCRIPTION OF THE SIGN

1: wheel motor structure
10: frame unit
110: left cover
111: left through hole
112: left heat radiating fin
120: the right cover
121: right through hole
122: right heat radiating fin
130: gasket
20: rotor
210: motor ring
220: wheel ring
230: permanent magnet
30: stator
310: core
320: slot
330: insulator
40: coupling shaft
50: harness
60: oil seal
70: dust cap
2: disc brake

1. A wheel motor structure comprising:
a stator which is formed in a disc shape and in which a plurality of slots are disposed along a circumference of the stator, wherein wires are wound in the plurality of slots;
a rotor which is disposed to surround an outer side of the stator in a radial direction, of which a central axis is positioned collinearly with a central axis of the stator, and which is rotatably coupled with respect to the stator;
a left cover coupled to one surface of the rotor to cover one surface of the stator;
a right cover coupled to the other surface of the rotor to cover the other surface of the stator;
a coupling shaft which passes through and is coupled to each of a central portion of the stator, a central portion of the left cover, and a central portion of the right cover; and
an oil seal disposed in a space between the coupling shaft and any one of the left cover and the right cover to seal the space,
wherein the rotor includes a motor ring formed in a ring shape and a wheel ring which is formed in a ring shape and of which an outer circumferential surface is tightly coupled to an inner circumferential surface of the motor ring, and
heat radiating fins extending in the radial direction are formed to protrude from both side surfaces of each of the left cover and the right cover

2. The wheel motor structure of claim 1, wherein, in the rotor, the inner circumferential surface of the motor ring and the outer circumferential surface of the wheel ring are coupled in a welding manner.

3. The wheel motor structure of claim 1, wherein a permanent magnet is disposed on an inner circumferential surface of the wheel ring.

4. The wheel motor structure of claim 3, wherein a plurality of permanent magnets are disposed along the inner circumferential surface of the wheel ring.

5. The wheel motor structure of claim 1, further comprising a dust cap coupled to any one of the left cover and the right cover with the oil seal interposed therebetween and disposed to surround the oil seal.

6. The wheel motor structure of claim 5, wherein a through hole is formed in a portion of the dust cap to allow a space between the dust cap and the oil seal to communicate with an outer space of the dust cap.

7. The wheel motor structure of claim 1, further comprising a gasket which is positioned between the rotor and any one of the left cover and the right cover, is tightly coupled to each of the rotor and any one of the left cover and the right cover, and seals a space between the rotor and any one of the left cover and the right cover.

8. The wheel motor structure of claim 7, wherein a sealant is applied on a periphery of the gasket.

9. The wheel motor structure of claim 1, further comprising a harness which includes a plurality of wires wired from the stator, passes through the coupling shaft, and extends in a direction away from the stator.

10. The wheel motor structure of claim 9, wherein a sealant is applied on a portion of the harness close to the coupling shaft.
